(19) United States
(12) Patent Application Publication
(10) Pub. No.: US 2021/0258088 A1
(43) Pub. Date: Aug. 19, 2021

(54) COMMUNICATIONS SYSTEM FOR LOCATING A KEY

(71) Applicant: CARRIER CORPORATION, Palm Beach Gardens, FL (US)

(72) Inventors: Neeraja Kanteti, Madhapur (IN); Adam Kuenzi, Salem, OR (US)

(21) Appl. No.: 16/973,827

(22) PCT Filed: Oct. 4, 2019
(86) PCT No.: PCT/US2019/054786

§ 371 Date: Dec. 10, 2020

(30) Foreign Application Priority Data
Oct. 18, 2018 (IN) 201811039483

(51) Int. Cl. H04B 17/27; H04B 17/318

(52) U.S. Cl. CPC H04B 17/27; H04B 17/318

(57) ABSTRACT

A method of locating a key includes sending a notification to a plurality of mobile devices, the notification configured to initiate, at the mobile devices, a scanning operation for the key; receiving reply messages from the mobile devices, at least one reply message including a key identifier, a signal strength and a location of the mobile device; and determining, from the reply messages, a location of the key.

### BACKGROUND

The embodiments herein relate generally to communications systems, and more particularly to a communications system for locating a key.

There are environments where several individuals have access to a key that is needed to use an object. For example, in an automotive sales environment, a person may show a vehicle to a potential buyer by opening a key container, removing a key and accessing the car. The person may forget to replace the key in the key container. At any point in time, it may be difficult to locate the key. Current systems, like the Supra Key Advantage keybox system (U.S. Pat. No. 7,061,367B2), record who accessed the key container to get a key in an audit record. But even if it is known who last retrieved the keys, the current location of the keys may still be unknown.

### SUMMARY

According to an embodiment, a method of locating a key includes sending a notification to a plurality of mobile devices, the notification configured to initiate, at the mobile devices, a scanning operation for the key; receiving reply messages from the mobile devices, at least one reply message including a key identifier, a signal strength and a location of the mobile device; and determining, from the reply messages, a location of the key.

In addition to one or more of the features described herein, or as an alternative, further embodiments of the method may include receiving a request from a requestor to locate the key prior to sending the notification.

In addition to one or more of the features described herein, or as an alternative, further embodiments of the method may include notifying the requestor of the location of the key.

In addition to one or more of the features described herein, or as an alternative, further embodiments of the method may include mapping a plurality of key identifiers to a plurality of object identifiers.

In addition to one or more of the features described herein, or as an alternative, further embodiments of the method may include wherein the request includes an object identifier.

In addition to one or more of the features described herein, or as an alternative, further embodiments of the method may include wherein the receiving reply messages from the mobile devices include receiving a first reply message including the key identifier, a first signal strength and a first location and receiving a second reply message including the key identifier, a second signal strength and a second location; wherein determining the location of the key includes using the first location when the first signal strength is greater than the second signal strength.

In addition to one or more of the features described herein, or as an alternative, further embodiments of the method may include wherein the receiving reply messages from the mobile devices include receiving a first reply message including the key identifier, a first signal strength and a first location and receiving a second reply message including the key identifier, a second signal strength and a second location; wherein determining the location of the key includes using the first signal strength and the second signal strength to determine a probable location of the key.

In addition to one or more of the features described herein, or as an alternative, further embodiments of the method may include wherein the sending the notification to the plurality of mobile devices occurs periodically.

In addition to one or more of the features described herein, or as an alternative, further embodiments of the method may include wherein the scanning operation is performed via a short range wireless capability of the mobile device.

In addition to one or more of the features described herein, or as an alternative, further embodiments of the method may include wherein the key includes a FOB having a transceiver to communicate with the mobile device during the scanning operation.

According to another embodiment, a system for locating a key includes a message unit configured to send a notification to a plurality of mobile devices, the notification configured to initiate, at the mobile devices, a scanning operation for the key; the message unit configured to receive reply messages from the mobile devices, at least one reply message including a key identifier, a signal strength and a location of the mobile device; and the message unit configured to determine, from the reply messages, a location of the key.

In addition to one or more of the features described herein, or as an alternative, further embodiments of the system may include wherein the message unit is configured to receive a request from a requestor to locate the key prior to sending the notification.

In addition to one or more of the features described herein, or as an alternative, further embodiments of the system may include wherein the message unit is configured to notify the requestor of the location of the key.

In addition to one or more of the features described herein, or as an alternative, further embodiments of the system may include wherein the message unit is configured to map a plurality of key identifiers to a plurality of object identifiers.

In addition to one or more of the features described herein, or as an alternative, further embodiments of the system may include wherein the request includes an object identifier.

In addition to one or more of the features described herein, or as an alternative, further embodiments of the system may include wherein the message unit is configured to receive a first reply message including the key identifier, a first signal strength and a first location and receive a second reply message including the key identifier, a second signal strength and a second location; the message unit is configured to determine the location of the key by using the first location when the first signal strength is greater than the second signal strength.

In addition to one or more of the features described herein, or as an alternative, further embodiments of the system may include wherein the message unit is configured to receive a first reply message including the key identifier, a first signal strength and a first location and receive a second reply message including the key identifier, a second signal strength and a second location; the message unit is configured to determine the location of the key by using the first signal strength and the second signal strength to determine a probable location of the key.

In addition to one or more of the features described herein, or as an alternative, further embodiments of the system may include wherein the message unit is configured to send the notification to the plurality of mobile devices periodically.

In addition to one or more of the features described herein, or as an alternative, further embodiments of the system may include wherein the scanning operation is performed via short range wireless capability of the mobile device.

In addition to one or more of the features described herein, or as an alternative, further embodiments of the system may include wherein the key includes a FOB having a transceiver to communicate with the mobile device during the scanning operation.

According to another embodiment, a computer program product, tangibly embodied on a computer readable medium, for locating a key, the computer program product including instructions that, when executed by a processor, cause the processor to perform operations including sending a notification to a plurality of mobile devices, the notification configured to initiate, at the mobile devices, a scanning operation for the key; receiving reply messages from the mobile devices, at least one reply message including a key identifier, a signal strength and a location of the mobile device; and determining, from the reply messages, a location of the key.

Technical effects of embodiments of the present disclosure include the ability to locate an object, such as a key, by sending notification to a plurality of mobile devices to search for the object.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts a communications system in an example embodiment;

FIG. 2 depicts a key and FOB in an example embodiment;

FIG. 3 depicts a process of locating a key in an example embodiment;

FIG. 4 depicts a key data in an example embodiment.

### DETAILED DESCRIPTION

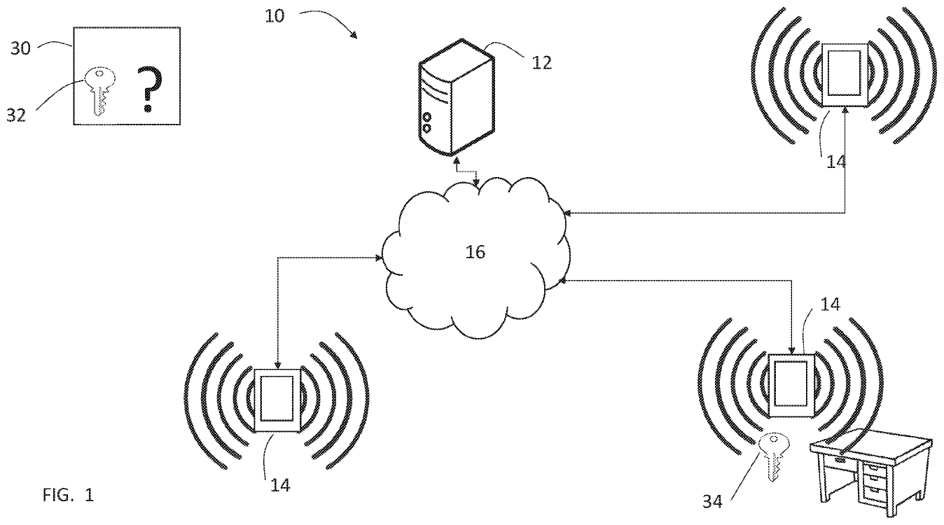

FIG. 1 depicts a communications system 10 in an example embodiment. The communications system 10 includes a message unit 12 that communicates with a plurality of mobile devices 14, registered with the message unit 12, when attempting to locate a key 32. The message unit 12 may be implemented using a processor-based device, such as a computer, server, cloud computing system, etc. The message unit 12 communicates with the mobile devices over a network 16. The network 16 may employ wired (e.g., LAN) and/or wireless (e.g., cellular, 802.xx, GSM) network topologies to communicate with the mobile devices 14 as is known in the art. Each mobile device 14 includes a short range wireless communication module than can send and receive communications. Example short range wireless communication modules include Bluetooth, NFC, Wi-Fi, IrDA, Li-Fi, Audio QR, etc. The mobile devices 14 may be implemented using processor-based devices such as smart phones, tablets, laptop computers, etc.

The communications system 10 operates to locate a key that is not at an expected location. In the example of FIG. 1, a cabinet 30 is used to store keys 32 and 34. The keys 32/34 may be car keys and the cabinet 30 located at a car dealer. The cabinet 30 may be a cabinet suitable for mounting in an office environment, or it may be a key container like the Supra Key Advantage keybox, the Supra Real Estate Lock box, or any other structure where it is sensible to store a key for use by multiple people. The term key is intended to include mechanical and electronic devices used to access an object, such as a vehicle. Examples of keys may include a physical mechanical or electro/mechanical key, electronic FOBs, RFID access cards, USB tokens, or the like. Under normal business practices, an individual who removes a key 32/34 from the cabinet 30 should return the key 32/34 to the cabinet 30 when use of the key 32/34 has ended. People forget to return the key to the cabinet 30, which leads to frustration in finding the key. In the example shown in FIG. 1, the key 34 was not returned to the cabinet 30 and is on someone's desk.

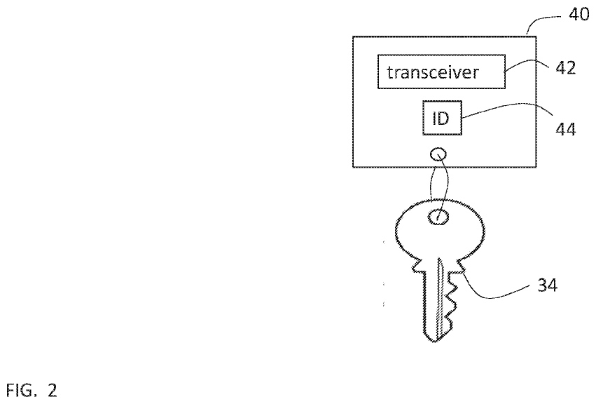

FIG. 2 depicts a key 34 and FOB 40 in an example embodiment. The key 34 and FOB 40 may be integrated into a single, electronic device which does not require physical interaction with a vehicle lock or ignition. The FOB 40 includes a transceiver 42 and a unique key identifier 44 stored in a memory of the FOB 40. When the FOB 40 receives an interrogation signal, the transceiver 42 sends the key identifier 44 as a reply message. The transceiver 42 is of a type to communicate with the short-range wireless communication module of the mobile devices 14. In one embodiment, the transceiver 42 is periodically activated to transmit the key identifier 44. In an embodiment, the transceiver 42 is a Bluetooth radio and the key identifier 44 is the Bluetooth address of the radio or a unique identifier transmitted by the Bluetooth radio.

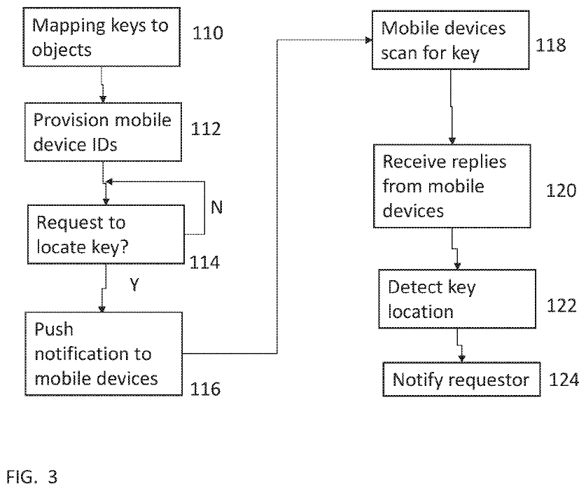

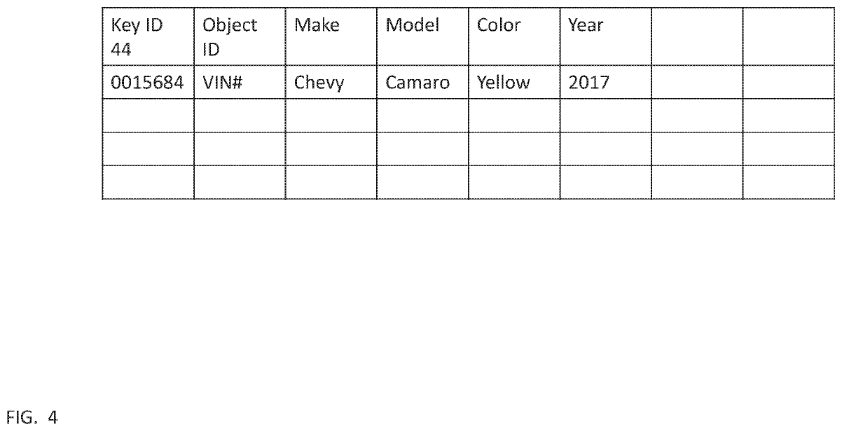

FIG. 3 depicts a process of configuring the communications system 10 and locating the key 34 in an example embodiment. The process begins at 110 where a mapping of keys to objects is performed. FIG. 4 depicts example key data created at block 110 of FIG. 3. The key data may be stored on the message unit 12. The key data may include the unique key identifier 44 mapped to a unique object identifier. The example object identifier in FIG. 4 is a vehicle identification number, or VIN. In this example, other object identifiers may be stored in the key data, such as make, model, color and year of the vehicle. Alternate examples could be made for keys used for other purposes. Another example is a house key and the key data may include a street address or a lock box identifier or a GPS coordinate of the location where the key is to be used. Another example is a pool key and the key data may include the clubhouse name. These identifiers may be used when the unique object identifier is not readily available.

Referring to FIG. 3, once the key identifiers are mapped to objects, flow proceeds to 112, where identifiers of the mobile devices 14 are stored in the message unit 12. An identifier of a mobile device 14 may be a phone numbers mobile identification number (MIN), or other unique identifier. In the example of FIG. 1, the mobile devices 14 would be those of employees of the car dealership. The identifiers of the mobile devices 14 stored in the message unit 12 can be updated as needed.

At 114, the message unit 12 determines if a request to locate a key has been received. Users of the mobile devices 14 may submit a request to the message unit 12 to locate a key by sending a message along with an object identifier to the message unit 12. The object identifier may be the unique object identifier or any of the other object identifiers in the key data. The request to locate the key may include the key identifier 44, if known. The message unit 12 retrieves the key identifier 44 from the key data by using the object identifier. In an example, a request to locate the key for a vehicle may include the object identifer VIN number. In another non-limiting example, a request to locate the key for a real estate showing may include the street address, a multiple listing service (MLS) listing identifier, a keybox serial number, or a GPS coordinate of the home for sale.

Once the message unit 12 receives a request to locate a key, flow proceeds to 116 where the message unit 12 sends a push notification to the mobile devices 14 over the network 16. The message unit 12 uses the identifiers of the mobile devices stored at block 112. The push notification instructs each mobile device 14 to scan for a key identifier 44 using the short range wireless protocol (e.g., Bluetooth). In this context, scanning is using the short range wireless capability of the mobile device 14 to either listen or query for a nearby key 32/34 and associated FOB 40. In one example embodiment, the short range wireless protocol is Bluetooth and scanning includes listening for a Bluetooth advertisement from the FOB 40. In another example, the protocol is Audio QR and scanning includes listening for an audio signal made by the FOB 40. In another example, the protocol is Li-Fi and scanning includes receiving a signal made by the FOB 40.

At 118, the mobile devices 14 scan for key identifier(s) 44 using the short range wireless protocol (e.g., Bluetooth). The mobile devices 14 may emit an interrogation signal. If a key 34 and FOB 40 are within range of the mobile device 14, the FOB 40 replies with or periodically sends its key identifier 44. At 120, each mobile device 14 replies back to the message unit 12 with a reply message including any key identifier 44 found, the signal strength of the signal received from the FOB 40 and the current location of the mobile device 14. The reply message may include a plurality of key identifiers 44 and a signal strength for each key identifier 44. The current location of the mobile device 14 may be derived using location data contained on the mobile device 14 (e.g., GPS).

At 120, the message unit 12 receives a reply message from all or enough of the mobile devices 14. The message unit 12 may discard reply messages including a key identifier 44 not matching the key identifier 44 of the requested key 34. At 122, the message unit 12 then determines the location of the key. If no reply message includes the key identifier 44 of the requested key 34, then the message unit 12 cannot determine the location of the key 34. If only a single reply message includes the key identifier 44 of the requested key 34, then the message unit 12 determines that the key 34 is located proximate to the mobile device 14 that sent the relevant reply message. The message unit 12 can then use the location of that one mobile device 14 as the location of the key 34. If more than one reply message includes the key identifier 44 of the requested key 34, then the message unit 12 determines that the key 34 is located proximate to the mobile device 14 having the highest signal strength of the signal received from the FOB 40. The message unit 12 can then use the location of the mobile device 14 having the highest signal strength of the signal received from the FOB 40 as the location of the key 34. The message unit 12 can also calculate the location of the key 34 based upon the location of each mobile device 14 and the signal strength from each mobile device to determine a region of probable location where the region is defined by a confidence level. The higher the confidence level, the smaller the region.

At 124, the message unit 12 notifies the requestor of the location of the key 34 by sending the location of the mobile device 14 that is nearest the key or the location as calculated by the message unit 12.

The operations performed by the message unit 12 and the mobile devices 14 occurs without user interaction, so that the method is performed seamlessly without the knowledge of the users of the mobile devices 14. In the example embodiment of FIG. 3, the key location process begins at the request of a requestor. In other embodiments, the message unit 12 periodically (e.g., once every 10 minutes) sends the push notifications to the mobile devices 14 to continuously monitor the locations of a plurality of keys. The method would operate in a similar manner as the message unit 12 continuously determines locations for every key.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of locating a key, the method comprising:
sending a notification to a plurality of mobile devices, the notification configured to initiate, at the mobile devices, a scanning operation for the key;
receiving reply messages from the mobile devices, at least one reply message including a key identifier, a signal strength and a location of the mobile device; and
determining, from the reply messages, a location of the key.

2. The method of claim 1 further comprising receiving a request from a requestor to locate the key prior to sending the notification.

3. The method of claim 2 further comprising notifying the requestor of the location of the key.

4. The method of claim 2 further comprising mapping a plurality of key identifiers to a plurality of object identifiers.

5. The method of claim 4 wherein the request includes an object identifier.

6. The method of claim 1 wherein:
the receiving reply messages from the mobile devices includes receiving a first reply message including the key identifier, a first signal strength and a first location and receiving a second reply message including the key identifier, a second signal strength and a second location;
wherein determining the location of the key includes using the first location when the first signal strength is greater than the second signal strength.

7. The method of claim 1 wherein:
the receiving reply messages from the mobile devices includes receiving a first reply message including the key identifier, a first signal strength and a first location and receiving a second reply message including the key identifier, a second signal strength and a second location;
wherein determining the location of the key includes using the first signal strength and the second signal strength to determine a probable location of the key.

8. The method of claim 1 wherein the sending the notification to the plurality of mobile devices occurs periodically.

9. The method of claim 1 wherein the scanning operation is performed via a short range wireless capability of the mobile device.

10. The method of claim 1 wherein the key includes a FOB having a transceiver to communicate with the mobile device during the scanning operation.

11. A system for locating a key, the system comprising:
a message unit configured to send a notification to a plurality of mobile devices, the notification configured to initiate, at the mobile devices, a scanning operation for the key;
the message unit configured to receive reply messages from the mobile devices, at least one reply message including a key identifier, a signal strength and a location of the mobile device; and
the message unit configured to determine, from the reply messages, a location of the key.

12. The system of claim 11 wherein the message unit is configured to receive a request from a requestor to locate the key prior to sending the notification.

13. The system of claim 12 wherein the message unit is configured to notify the requestor of the location of the key.

14. The system of claim 12 wherein the message unit is configured to map a plurality of key identifiers to a plurality of object identifiers.

15. The system of claim 14 wherein the request includes an object identifier.

16. The system of claim 11 wherein:
the message unit is configured to receive a first reply message including the key identifier, a first signal strength and a first location and receive a second reply message including the key identifier, a second signal strength and a second location;
the message unit is configured to determine the location of the key by using the first location when the first signal strength is greater than the second signal strength.

17. The method of claim 11 wherein:
the message unit is configured to receive a first reply message including the key identifier, a first signal strength and a first location and receive a second reply message including the key identifier, a second signal strength and a second location;
the message unit is configured to determine the location of the key by using the first signal strength and the second signal strength to determine a probable location of the key.

18. The system of claim 11 wherein the message unit is configured to send the notification to the plurality of mobile devices periodically.

19. The system of claim 11 wherein the scanning operation is performed via short range wireless capability of the mobile device.

20. The system of claim 11 wherein the key includes a FOB having a transceiver to communicate with the mobile device during the scanning operation.

21. A computer program product, tangibly embodied on a computer readable medium, for locating a key, the computer program product including instructions that, when executed by a processor, cause the processor to perform operations comprising:
sending a notification to a plurality of mobile devices, the notification configured to initiate, at the mobile devices, a scanning operation for the key;
receiving reply messages from the mobile devices, at least one reply message including a key identifier, a signal strength and a location of the mobile device; and
determining, from the reply messages, a location of the key.
